(19) United States
(12) Patent Application Publication
(10) Pub. No.: US 2022/0084483 A1
(43) Pub. Date: Mar. 17, 2022

(54) METHODS, SYSTEMS, ARTICLES OF MANUFACTURE, AND APPARATUS TO DESIGNATE A DISPLAY EXCLUSIVE ZONE OF A DISPLAY SCREEN

(71) Applicant: Sean J. W. Lawrence, Bangalore (IN)

(72) Inventor: Sean J. W. Lawrence, Bangalore (IN)

(21) Appl. No.: 17/483,551

(22) Filed: Sep. 23, 2021

(51) Int. Cl. G09G 5/14

(52) U.S. Cl. CPC G09G 5/14; G09G 2370/02; G09G 2340/0464

(57) ABSTRACT

Methods, apparatus, systems, and articles of manufacture are disclosed to designate a display exclusive zone of a display screen. An example computing device to designate a display exclusive zone as disclosed includes at least one memory, instructions in the compute device, and processor circuitry to execute the instructions to designate a portion of a display screen as a display exclusive zone, the display exclusive zone having a first spatial location, the display exclusive zone including first content. The example computing device also includes, in response to receiving a request to render second content, determining a second spatial location of the second content, in response to determining the second spatial location encroaches the first spatial location, adjusting the second spatial location to a third spatial location; and rendering the second content in the third spatial location.

### FIELD OF THE DISCLOSURE

This disclosure relates generally to display screens and, more particularly, to methods, systems, articles of manufacture, and apparatus to designate a display exclusive zone of a display screen.

### BACKGROUND

In multi-application multi-window systems such as Microsoft® Windows® and Linux®, an instance of an application is rendered in a rectangular graphical element called a window. In such multi-windowed systems, a newly rendered application window may overlap with a previously rendered application window. A user of a multi windowed system may manually adjust rendered content within a display screen.

### BRIEF DESCRIPTION OF THE DRAWINGS

FIG. 1 is a block diagram illustrating an example system to designate and control an example display exclusive zone in accordance with the teachings disclosed herein.

FIG. 2 is an illustration of an example display exclusive zone configured under an example first mode of operation on an example display screen.

FIG. 3 is a block diagram of example application rendering managing circuitry of FIG. 1 constructed in accordance with the teachings of this disclosure.

FIG. 4 illustrates an example notification window that renders on a display screen without a designated display exclusive zone.

FIG. 5 illustrates the example notification window of FIG. 4 as it renders on a display screen with a designated display exclusive zone in accordance with the teachings of this disclosure.

FIGS. 6-7 illustrate additional example display exclusive zones configured under an example second mode in accordance with the teachings of this disclosure.

FIGS. 8-10 are flowcharts representative of example machine-readable instructions that may be executed by the example application rendering system of FIG. 1 and/or FIG. 3.

FIG. 11 is a block diagram of an example processing platform including processor circuitry structured to execute the example machine readable instructions of FIG. 8, FIG. 9 and/or FIG. 10 to implement the application rendering system of FIG. 1 and FIG. 3.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 8-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication.” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

### DETAILED DESCRIPTION

As noted above, multi-application multi-window systems render (e.g., on a display) applications in rectangular graphical elements called windows. An instance of an application rendering may cause the application window to overlap with another application window. For example, a newly rendered application window may overlap (e.g., at least partially cover) with a previously rendered application window. In some scenarios, a user may desire to see content of the previously rendered application while interacting with the newly rendered application. Current systems allow a user to re-size and/or move an application window manually. However, manually re-sizing and/or moving windows when a new application renders on the display may be inconvenient to the user. Further, notifications and/or other applications may render without user involvement due to background scripts, triggers, and/or reminders. For example, an application window may render one or more notifications to a user of a newly received email. Such application window rendering may be caused by default operating system and/or application setting, which may interfere with an interactive focus of another application window that is rendered on a display screen.

In some examples, users with large display screens manually re-size and organize multiple windows into differing sections of the display screen. For example, a user may size and orientate an application window such that the application window occupies a first half of example display screen real estate. The user may cause a second half of the display screen real estate to occupy two additional application windows, each of the two application windows occupying a first and second quarter of the display screen real estate. In this example scenario, the user would have three application windows rendered, each of which occupy three separate portions of the display screen and each remaining in interactive focus. As disclosed herein, interactive focus refers to a user's ability to interact with an application window, such as being able to use a search bar on a webpage. However, manually sizing and orientating the application windows may be an inconvenience to the user. Further, nothing is to prevent other application windows from rendering in such a way that takes a previously rendered application window out of interactive focus. For example, a user may be actively editing a document on a computing device. In such a scenario, an application window may render alerting the user to a newly available update for an operating system on the computing device. In some scenarios, the application window with the alert may render in a manner that overlaps with the document the user was editing, thereby taking the document out of interactive focus.

Examples disclosed herein provide a method and apparatus to configure a display exclusive zone within at least one display screen. A display exclusive zone as disclosed herein is a designated portion of a display screen that renders specific content. Examples disclosed herein provide methods, systems, articles of manufacture, and apparatus to configure a size and position of a display exclusive zone. In some examples, the display exclusive zone is pre-configured. For example, a maker of a laptop (e.g., a company) may sell a laptop that comes with a pre-configured display exclusive zone upon purchase. In some examples, a purchaser may then re-configure the display exclusive zone. In some examples, the display exclusive zone is user-configured. For example, a laptop may come with the means to configure a display exclusive zone, but a purchaser may initially configure the display exclusive zone as they please.

Examples disclosed herein prevent an application window from encroaching a boundary of the configured display exclusive zone. In examples disclosed herein, a user may switch-off a designated display exclusive zone. For example, a user may switch off a display exclusive zone if the user if the user desires to use the entire of the display screen to watch a film. Accordingly, examples disclosed herein allow a user to work more effectively and simultaneously with multiple application windows in multi-window multi-application systems.

Examples disclosed herein provide differing modes of operation of an example display exclusive zone. In some example modes, a display exclusive zone is configured in terms of screen real estate. In some example modes, a display exclusive zone is configured and/or otherwise controlled via a display driver (e.g., display driver circuitry corresponding to a computing platform). In some example modes, a display exclusive zone is configured and/or otherwise controlled via an operating system of a user device. In some example modes, a display exclusive zone is configured and/or otherwise controlled via an application having a user interface. In some example modes, a display exclusive zone is rendered as an application window. In some modes, instructions and circuitry may resize an instance of an application rendering to prevent the application window from overlapping and/or encroaching a boundary of a display exclusive zone. In some example modes, an instance of an application may render behind a display exclusive zone. In such example modes, an application window may render behind a display exclusive zone as long as the application remains in interactive focus. In such example modes, an instance of the application rendering may be moved and/or re-sized if a rendering will take the application window out of interactive focus.

In some examples disclosed herein, a user manually deposits a rendered application window within an example display exclusive zone to convert the application window to display exclusive content. As disclosed herein, display exclusive content refers to content that resides within the display exclusive zone. In some examples disclosed herein, a user designates an application as a display exclusive application wherein the display exclusive application will render in the display exclusive zone without manual intervention. In such examples as disclosed herein, a user may designate a new display exclusive application thereby replacing the previously designated display exclusive application. Examples disclosed herein may prevent another application from rendering within a designated display exclusive zone.

Examples disclosed herein provide methods, systems, articles of manufacture, and apparatus for contextual application rendering. In some examples disclosed herein, an application window that is to be rendered outside a display exclusive zone is re-sized and/or re-arranged prior to rendering. In some examples disclosed herein, an application window is re-sized and/or re-arranged based on prior user usage data. In some examples, an application window is re-sized and/or re-arranged based on crowdsourced usage contexts and/or recommendations. In some examples, machine learning is applied to create rendering models that determine a size and location of multiple application windows. Accordingly, some example disclosed herein optimize a user's experience when working simultaneously with multiple application windows.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a reinforcement learning model is used. However, other types of machine learning models/techniques could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, unsupervised training (e.g., used in deep learning, a subset of machine learning, etc.) involves inferring patterns from inputs to select parameters for the ML/AI model (e.g., without the benefit of expected (e.g., labeled) outputs). Alternatively, supervised training uses inputs and corresponding expected (e.g., labeled) outputs to select parameters (e.g., by iterating over combinations of select parameters) for the ML/AI model that reduce model error.

In examples disclosed herein, ML/AI models are trained using a policy-based algorithm, but examples disclosed herein are not limited thereto. However, any other training algorithm may additionally or alternatively be used. Training is performed using hyperparameters that control how the learning is performed (e.g., a learning rate, a number of layers to be used in the machine learning model, etc.) Training is performed using training data. In examples disclosed herein, the training data originates from user usage data. In some examples disclosed herein, the training data originates form crowdsourced usage data.

Once training is complete, the model is deployed for use as an executable construct that processes an input and provides an output based on the network of nodes and connections defined in the model. The model is stored at in a rendering model database. The model may then be executed by display determining circuitry.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

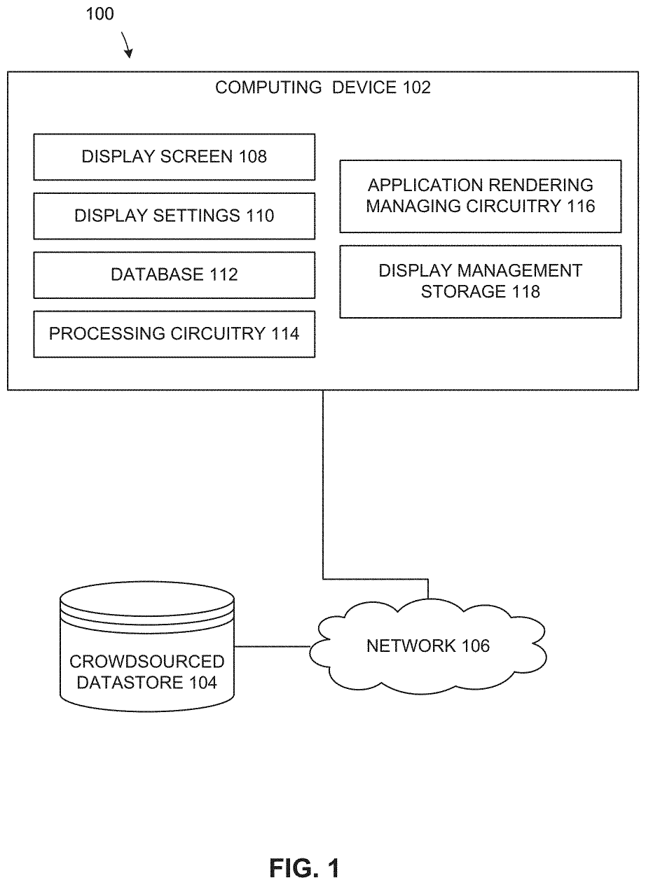

FIG. 1 illustrates an example application rendering system 100 construed in accordance with the teachings of this disclosure for designating at least one display exclusive zone. The example system 100 includes an example computing device 102, an example crowdsourced datastore 104, and an example network 106. The example computing device 102 can be any suitable compute device. For example, the computing device 102 may be any type of user device, such as a personal computing (PC) device such as a laptop, a desktop, an electronic tablet, a hybrid or convertible PC, a mobile telephone, etc.

The example crowdsourced datastore 104 of FIG. 1 is storage circuitry that stores information and/or data related to contextual usage of application(s) from resources such as surveys, user inputs, etc. In operation, the example computing device 102 may request contextual information regarding application usage, including size and layout recommendations, models, and/or usage contexts, via the example crowdsourced datastore 104. While in the illustrated example of FIG. 1 the crowdsourced datastore 104 is illustrated as a single datastore, the crowdsourced datastore 104 may be implemented by any number and/or type(s) of datastores. Furthermore, the data stored in the crowdsourced datastore 104 may be in any data format such as, for example, binary data, comma delimited data, tab delimited data, structured query language (SQL) structures, an executable (e.g., an executable binary, a configuration image, etc.), etc.

In some examples, the example crowdsourced datastore 104 is communicatively coupled to the computing device 102 via the example network 106. In the illustrated example of FIG. 1, the network 106 is the Internet. However, the example network 106 may be implemented using any other network over which data can be transferred. The example network 106 may be implemented using any suitable wired and/or wireless network(s) including, for example, one or more data buses, one or more Local Area Networks (LANs), one or more wireless LANs, one or more cellular networks, one or more private networks, one or more public networks, among others. In additional or alternative examples, the network 106 is an enterprise network (e.g., within businesses, corporations, etc.), a home network, among others.

The example network 106 enables the computing device 102 and the crowdsourced datastore 104 to communicate. In some examples, the network 106 is not always connected to the user computing devices 102. As used herein, the phrase “in communication,” including variances thereof (e.g., communicate, communicatively coupled, etc.), encompasses direct communication and/or indirect communication through one or more intermediary components and does not require direct physical (e.g., wired) communication and/or constant communication, but rather includes selective communication at periodic or aperiodic intervals, as well as one-time events.

The example computing device 102 of FIG. 1 includes an example display screen 108, example display settings 110, an example database 112, example processing circuitry 112, example application rendering management circuitry 114, and example display management storage 116. In some examples, one or more of the examples components of the computing device 102 may be incorporated in, or otherwise form a portion of, another component.

In some examples, the display screen 108 is part of the computing device 102, such as when the computing device 102 is an electronic tablet. In some examples, the display screen 108 is physically attached to the computing device 102, such as when the computing device 102 is a laptop. In some examples, the display screen 108 is communicatively coupled to the computing device 102, such as when a computing device 102 is a personal computing device that is coupled to a monitor. In some examples, the computing device 102 is part of and/or connected to and/or communicatively coupled to more than one display screen 108. For example, a computing device 102 such as a laptop may have a first display screen 108 physically attached to the computing device 102, a second display screen 108 (e.g., monitor) communicatively coupled to the computing device 102 via a hardware interface (e.g., USB Port, etc.), and a third display screen 108 (e.g., monitor) communicatively coupled to the computing device 102 via a wireless connection (e.g., Bluetooth, etc.). In some examples, the display screen 108 is larger than 17 inches. However, any display screen 108 capable of displaying more than one application window may be used.

The display screen 108 may be any type of display on which information may be displayed to a user of the compute device 102, such as a touchscreen display, a liquid crystal display (LCD), a light emitting diode (LED) display, a cathode ray tube (CRT) display, a plasma display, an image projector, a laser projector, and/or other suitable display technology.

Example display settings 110 include information and instructions regarding display settings designated for a display screen 108 that is communicatively coupled to the computing device 102. In some examples, the display settings 110 include information and instructions for displays screens that are communicatively coupled to the computing device 102. In some examples, at least a portion of the display settings 110 are configured via a display driver. In some examples, at least a portion of the display settings 110 are configured via an operating system of the computing device 102. In some examples, at least a portion of the display settings 110 are pre-configured. The display settings 110 may also be configurable by a user. In some examples, the display settings 110 are stored in example database 112. In some examples, the display settings 110 are stored elsewhere within the computing device 102. In some examples, the display settings 110 include how many display screens 108 are in use, dimensions of each display screen, etc.

In some examples, the database 112 is stored within the computing device 102. In some examples, the database 112 is located external to the computing device 102 in a location accessible to the computing device 102 (e.g., a network accessible location). The example database 112 of the illustrated example of FIG. 1 is implemented by any memor(ies), storage device(s) and/or storage disc(s) for storing data such as, for example, flash memory, magnetic media, optical media, etc. Furthermore, the data stored in the example database 112 may be in any data format such as, for example, binary data, comma delimited data, tab delimited data, structured query language (SQL) structures, image data, etc.

The example computing device 102 of FIG. 1 includes processing circuitry 114 that executes software. In some examples, the processing circuitry 114 is communicatively coupled to additional processor circuitry. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

The example computing device 102 of FIG. 1 includes example application rendering managing circuitry 116. The example application rendering managing circuitry 116 is construed to configure a display exclusive zone and to render applications. In some examples, the application rendering managing circuitry 116 is configured to contextually render applications using a machine learning model. In some examples, the application rendering manager circuitry 116 can be implemented by one or more processors of the computing device 102. For example, the application rendering managing circuitry 116 may implemented by processing circuitry 114 and/or other processors and/or hardware components of the computing device 102. In some examples, the application rendering managing circuitry 116 is implemented by the processing circuitry 114 (e.g., a system of on chip (SOC)). In some examples, the application rendering managing circuitry 116 is instantiated by processor circuitry such as a central processing unit executing instructions. In some examples, the application rendering manager circuitry 116 may be instantiated by an application specific integrated circuit (ASIC) or a field programmable gate array (FPGA) structured to perform operations corresponding to the instructions. In some examples, the application rendering managing circuitry 116 is implemented by one or more cloud-based devices, such as such as one or more servers, processors, and/or virtual machines and/or containers located remotely from the computing device 102. In other examples, some of the tasks performed by the application rendering managing circuitry 116 is implemented by cloud-based devices and other parts of the analysis are implemented by local processor(s) or one or more computing device(s).

The example computing device 102 of FIG. 1 includes example display management storage 118. The display management storage 118 stores information regarding display exclusive zone configurations and/or machine learning models. The display management storage 118 may be implemented by any memor(ies), storage device(s) and/or storage disc(s) for storing data such as, for example, flash memory, magnetic media, optical media, etc. Furthermore, the data stored in the example display management storage 118 may be in any data format such as, for example, binary data, comma delimited data, tab delimited data, structured query language (SQL) structures, image data, etc.

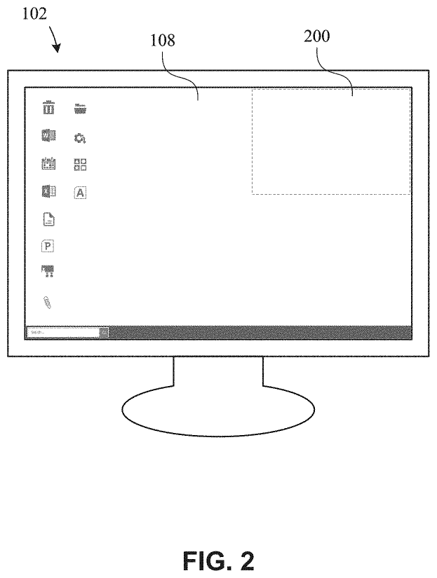

FIG. 2 is an illustration of an example display exclusive zone 200 configured within an example display screen (e.g., display screen 108) that is communicatively coupled to an example computing device (e.g., computing device 102). In this example, the computing device 102 is a personal desktop computer with a built-in display screen 108. In this example, the example display exclusive zone 200 is configured under an example first mode of operation. However, the display exclusive zone 200 may be configured under one or more other modes of operation. Content as disclosed herein refers to any information that renders in a graphical element (e.g., window) within a display screen 108. Content may include application windows, notifications, etc. In some examples, content is rendered after the computing device 102 receives a request to render the content. In some examples, a user initiates a request to render content via one or more peripherals such as a keyboard, a mouse, a touchscreen, etc. that are in communication with the computing device 102. In some examples, the content includes a background application that does not require ongoing interactions with a user. Accordingly, in some examples, a background application may initiate a rendering of an application window independent of a user. For example, a background application may have an independent (e.g., independent of the user) process and/or circuitry that can render content on the display screen 108. For example, an operating system of the computing device 102 may be capable of generating a notification that a new update for the operating system is available.

As noted above, the example display exclusive zone 200 operates under a first mode of operation. Under the example first mode of operation, the example display exclusive zone 200 is configured to occupy screen real estate. In some examples, a display exclusive zone 200 is configured via a display driver of the computing device 102. However, the display exclusive zone 200 may additionally and/or alternatively be configured via one or more operating system settings of the computing device 102. Although the example display exclusive zone 200 of FIG. 2 is configured as a single window in a corner of the display screen 108, other suitable manners of configuring the display exclusive zone 200 are possible. For example, the display exclusive zone 200 may occupy a different portion of the display screen 108 and/or be configured to occupy a smaller or larger portion of the display screen 108. Additionally, and/or alternatively, multiple display exclusive zones 200 may be configured. For example, a user may configure two display exclusive zones 200 for a single computing device 102. In some examples, a first one of the two display exclusive zones 200 may be configured to occupy a quadrant of screen real estate of the display screen 108. In some examples, a second one of the two display exclusive zones 200 may occupy another portion of screen real estate of the computing device 102. In other examples, a second one of the two display exclusive zones 200 may be configured to occupy a portion of a display screen 108 (e.g., a monitor) that is communicatively coupled to the computing device 102. In some examples, a second one of the two display exclusive zones 200 may be configured under a different mode of operation. In any case, a user may configure any suitable number of display exclusive zones 200 in any suitable manner.

Content that is rendered within an example display exclusive zone 200 will remain display exclusive. That is, content occupying the display exclusive zone 200 will remain in view by a user as long as the computing device 102 is active and the display exclusive zone remains on. A user who desires to have specific content rendered within a display exclusive zone 200 may manually move a desired application window into the display exclusive zone 200. The desired application will then become display exclusive, and newly rendered content on any other portion of the display screen 108 will not obstruct the user's view of the application within the example display exclusive zone 200. For instance, in the event the operating system is triggered to render content on the display screen 108 in a location overlapping the display exclusive zone 200, examples disclosed herein will preserve and/or otherwise prevent disruption of the content rendered by the application within the display exclusive zone 200. In some examples, an application may be designated as a display exclusive application. In such examples, the display exclusive application will render within the display exclusive zone 200 when the application is launched. In some examples, content rendered in a display exclusive zone 200 is re-sized to a size of the display exclusive zone 200 prior to rendering. In some examples, content rendered in a display exclusive zone 200 maintains its original size.

So long as a display exclusive zone 200 is occupied by an application, other content to be rendered will render in portions of the display screen 108 not designated as a display exclusive zone 200. In other words, other content that is rendered within the display screen 108 will not render in a manner that causes a portion of the content to overlap with a display exclusive zone 200. In some examples, however, applications may render in such a manner as to cover and/or overlap a display exclusive zone 200 if a display exclusive zone 200 is not occupied with a display exclusive application. In some examples, a user may move content that is outside of a display exclusive zone 200 into the display exclusive zone 200, thereby converting the content into display exclusive content. In some examples, content that is not display exclusive content but will render in such a manner as to obstruct the display exclusive zone 200 while the display exclusive zone is occupied may be re-sized and/or moved. For example, content to be rendered within the display screen 108 that is not to be rendered within the display exclusive zone 200 may be rendered a measured distance away from the display exclusive zone 200 in order to prevent an application window from overlapping with a portion of the display exclusive zone 200. In some examples, content to be rendered within a portion of the display screen 108 that is not the display exclusive zone 200 may be contextually rendered (e.g., intelligently rendered). For example, user usage data may be applied to determine the context in which the user uses an application. The application may be rendered in a portion of the display screen 108 according to the contextual usage of the application. In some examples, usage and size recommendations may additionally and/or alternatively be retrieved from a crowdsourced datastore (e.g., crowdsourced datastore 104) and applied when rendering the application. In some examples, machine learning is applied to determine where to render content that is to be rendered within the display screen 108, but outside the bounds of the display exclusive zone 200.

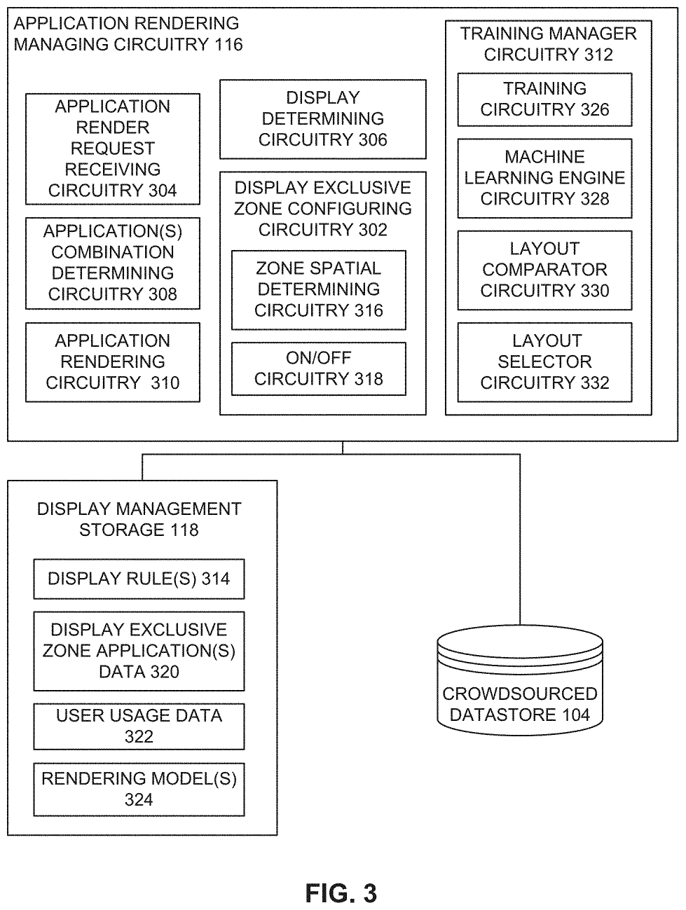

FIG. 3 is a block diagram of an example implementation of the example application rendering managing circuitry 116 of FIG. 1. As mentioned above, the application rendering manager circuitry 116 is construed to configure a display exclusive zone (e.g., display exclusive zone 200) and to render an application. The example application rendering managing circuitry 116 includes example display zone configuring circuitry 302, application render request receiving circuitry 304, example display determining circuitry 306, example application combination determining circuitry 308, example application rendering circuitry 310, and example training manager circuitry 312.

As illustrated in FIG. 3, the example application rendering managing circuitry 116 is communicatively coupled to the example display management storage 118. The display management storage 118 stores information related to display exclusive zone configuration and contextual rendering. In some examples, the display management storage 118 is included in the application rendering manager circuitry 116. In some examples, the display management storage 118 is located external to the computing device 102 in a location accessible to the application rendering managing circuitry 116. The application rendering managing circuitry 116 can request information from the display management storage 118 when configuring a display exclusive zone 200, when rendering an application, and/or training a rendering model.

As noted, the application rendering managing circuitry 116 includes example display exclusive zone configuring circuitry 302, which configures a display exclusive zone (e.g., display exclusive zone 200). The display exclusive zone configuring circuitry 302 configures a display exclusive zone 200 according to its mode of operation. In the illustrated example of FIG. 3, information regarding differing modes of operation of an example display exclusive zone 200 is stored in example display rules 314. However, information regarding a mode of operation of a display exclusive zone may be stored in another area of the computing device 102. In some examples, information regarding a mode of operation may be stored outside the computing device 102 in a location accessible by the application rendering managing circuitry 116. The display exclusive zone configuring circuitry 302 may request information from the display rules 314 during configuration of a display exclusive zone 200.

In some examples, the display exclusive zone configuring circuitry 302 allows and/or otherwise facilitates configuration (e.g., by a user) of more than one display exclusive zone 200 within a display screen 108 and/or for more than one display screen 108. In some examples, the display exclusive zone configuring circuitry 302 allows a user to configure a display exclusive zone 200 according to a first mode of operation. In some examples, the display exclusive zone configuring circuitry 302 allows configuration of a display exclusive zone 200 according to a second mode of operation. In some examples, the display exclusive zone 200 mode is pre-determined. In some examples, the display exclusive zone configuring circuitry 302 allows configuration of a display exclusive zone 200 according to other modes of operations. In some examples, the display exclusive zone 200 mode is pre-determined. In some examples, the display exclusive zone 200 is restricted by the display exclusive zone configuring circuitry 302 to allow particular types of configuration. In some examples, only a size and location of a pre-determined display exclusive zone mode are permitted. The example display exclusive zone configuring circuitry 302 of FIG. 3 allows configuration of a size and/or position of a display exclusive zone 200. For example, a user or policy (e.g., a policy containing particular configuration parameters enforce and/or otherwise managed by an entity (e.g., a company)) may configure the display exclusive zone 200 to occupy a quadrant of a display screen 108. Additionally, or alternatively, the user or policy may configure the display exclusive zone 200 to occupy half of the display screen 108.

The display exclusive zone configuring circuitry 302 includes example zone spatial determining circuitry 316. The example zone spatial determining circuitry 316 determines a size and a position of a display exclusive zone 200 that has been configured within a display screen 108. In some examples, the zone spatial determining circuitry 316 uses the size and position of the display exclusive zone 200 to determine a size and shape of the display screen 108 that is not display exclusive.

The example display exclusive zone configuring circuitry 302 also includes on/off circuitry 318, which allows a configured display exclusive zone 200 to be switched off or on (e.g., as the user desired and/or as regulated by a policy). In some examples, switching a display exclusive zone 200 off will cause a newly rendered application to render as the application would absent a display exclusive zone 200. In some examples, switching a display exclusive zone 200 off will not affect the contextual rendering ability of the application rendering managing circuitry 116. That is, the application rendering circuitry 116 will continue to contextually render an application regardless of whether the display exclusive zone is switched off.

The application rendering managing circuitry 116 receives and/or retrieves an application rendering request via example application render request receiving circuitry 304. In some examples, the application render request receiving circuitry 304 receives user-initiated application rendering requests. For example, the application render request receiving circuitry 304 may receive a request to render an application, such as a webpage, that was initiated (e.g., by a user) via a peripheral device. In some examples, the application render request receiving circuitry 304 receives a request to render an application from a background application running a background script. For example, an instant messaging application may continually run in the background. The example application render request receiving circuitry 304 may receive a request from the instant messaging application to render a notification window to notify a user of an instant message sent received from another device.

The example application rendering managing circuitry 116 includes example display determining circuitry 306. The display determining circuitry 306 determines a current status of a display screen 108 and, with the determined display screen status, determines where to render an application within the display screen 108. Upon the application render request receiving circuitry 304 receiving a request to render an application, the application rendering managing circuitry 116 causes the example display determining circuitry 306 to determine a status of a display screen 108 of the computing device 102. A status of a display screen 108 as disclosed herein includes various information, including a size of the display screen(s) 108, display settings (e.g., display settings 110), display exclusive information, etc. For example, the display determining circuitry 306 determines if a display exclusive zone 200 is configured and, if so, whether the display exclusive zone 200 is switched off In such an example, in response to determining a display exclusive zone 200 is configured and not switched off, the display determining circuitry 306 determines a size and position of the display exclusive zone 200. Using information about the size of the display screen 108 and a size and position of a display exclusive zone 200, the display determining circuitry 306 calculates a status of available screen real estate for rendering an application.

To assist the display determining circuitry 306 in determining where to render an application, the application rendering managing circuitry 116 includes example application combination determining circuitry 308. Upon the application render request receiving circuitry 304 receiving a request to render an application, the application rendering managing circuitry 116 causes the application combination determining circuitry 308 to determine a current combination of applications rendering on a display screen 108. In some examples, a current combination of applications includes the application for which the request to render was initiated.

In the illustrated example of FIG. 3, if the application combination determining circuitry 308 determines that the combination of applications includes only the application for which the rendering request was initiated, the display determining circuitry 306 determines whether the application is a display exclusive application. The display determining circuitry 308 determines whether an application is a display exclusive application by requesting information from the display exclusive zone application data 320. The display exclusive zone application data 320 stores information regarding designated display exclusive zone applications. That is, some examples as disclosed herein allow designation of a specific application as a display exclusive application, as described above. In the illustrated example of FIG. 3, the display exclusive zone application data 320 is stored in the display management storage 118. In other examples, the display exclusive zone application data 320 is stored within the application rendering managing circuitry 116. In some examples, the display exclusive zone application data 320 may be stored elsewhere.

If the display determining circuitry 306 determines that the application is a display exclusive application and the display exclusive zone is on, the display determining circuitry 306 will generate instructions to cause the application to render in the display exclusive zone 200. If the display determining circuitry 306 determines that the application is not a display exclusive application and the display exclusive zone is on, the display determining circuitry 306 generates instructions to cause the application to render in another portion of the display screen which will not cause obstruction of the display exclusive zone 200. In some examples, the display determining circuitry 306 requests information from the user usage data 322 and/or crowdsourced datastore 104 to determine where the render the application. In the illustrated example of FIG. 3, the user usage data 322 is stored in the display management storage 118. In some examples, the display exclusive zone application data 322 is stored within the application rendering managing circuitry 116. In some examples, the display exclusive zone application data 320 may be stored elsewhere in a location accessible by the application rendering managing circuitry 116.

In the illustrated example of FIG. 3, if the application combination determining circuitry 308 determines that the combination of applications includes more than one application, the display determining circuitry 308 determines whether a rendering model 324 exists for the current combination of applications. In some examples, the display determining circuitry 308 determines whether a rendering model 324 exists for the current combination of applications even if the current combination of applications includes only one application. In some examples, rendering models 324 are stored in the display management storage 118. In some examples, rendering models are stored within the application rendering managing circuitry 116. In some examples, the rendering models are stored in another location of the computing device 102, such as the database 112. In some examples, the rendering models 324 are stored in a device that is separate from the computing device 102 that is communicatively coupled to the computing device 102 via the example network 106 of FIG. 1. If the application determining circuitry 306 determines that a model exists for the current combination of applications, the application determining circuitry 306 generates instructions to cause the application to render the application according to the model.

The example application rendering management circuitry 310 includes an example application rendering circuitry 310. The application rendering circuitry 310 is configured to render applications according to instructions generated by the display determining circuitry 306.

The application rendering managing circuitry 116 includes example training manager circuitry 312, including example training circuitry 326, example machine learning engine circuitry 328, example layout comparator circuitry 330, and example layout selector circuitry 332. The training circuitry 326 trains the machine learning engine circuitry 328 with user usage data 322 and/or crowdsourced datastore 104 and/or display rules 314 to recognize patterns and/or associations and follow such patterns and/or associations when processing input data (e.g., the current combination of applications). The machine learning engine circuitry 328 outputs a rendering model 324 consistent with the recognized patterns and/or associations. In other words, the training circuitry 326 trains the machine learning engine circuitry 328 using user usage data 322 and/or crowdsourced datastore 104 and/or display rules 314 to generate one or more rendering models 324. In some examples, the training manager circuitry 312 is implemented by the application rendering managing circuitry 116. In some examples, the training manager circuitry 312 is implemented by different processing circuitry of the computing device 102. In other examples, the training manager circuitry 312 is implemented by one or more cloud-based services, such as one or more servers, processors, and/or virtual machines. In some examples, some of the analysis performed by the training manager circuitry 312 is implemented by cloud-based devices and other parts of the analysis are implemented by processor(s) or one or more computing device(s).

User usage data 322 includes user application usage information and user application preferences. In some examples, user usage data 322 may include information concerning where a user typically places a certain application window and/or input user preferences regarding location and size of the application window. In some examples, user usage data 322 includes application context information. For example, if the application is a Microsoft® Word® document, the data may include a recommendation that the application be kept in a location that allows interactive focus because the user may be editing the document. In some examples, user usage data 322 includes user input. For example, a user may input preferences concerning specific applications.

Crowdsourced datastore 104 includes various information from resources. In some examples, the crowdsourced datastore 104 includes general application context. For example, an application window such as a Microsoft® Word® document may include information indicating that the application window often involves user interaction. On the other hand, for example, an application window such as Apple® iTunes® would include information indicating that the application window can remain behind other applications because such an application may not maintain user interaction. In some examples, crowdsourced datastore 104 includes size recommendations for a particular application window. In some examples, crowdsourced datastore 104 may include rules for determining how to orientate an application window, as described in further detail below. In some examples, crowdsourced datastore 104 includes models for rendering a current combination of applications.

The display rules 314 include rules concerning display rendering. For example, if the display exclusive zone 200 is not configured and/or turned off, a display rule may conclude that an application may render anywhere within the display screen 108. The display rules 314 also includes rules regarding the differing modes of configuring a display exclusive zone 200, as noted above.

The training circuitry 326 uses input data, including the current combination of applications and usage data, to create layout options for rendering the current combination of applications. The layout comparator circuitry 330 compares the multiple layout options in light of the input data, including user usage data, crowdsourced data, and display rules 314. The layout selector circuitry 332 is configured to select a layout based on the layout comparator circuitry 330. The example training circuitry 326 generates a rendering model based on the selected layout of the layout selector 326. The training circuitry 326 stores the rendering model in the rendering models 324.

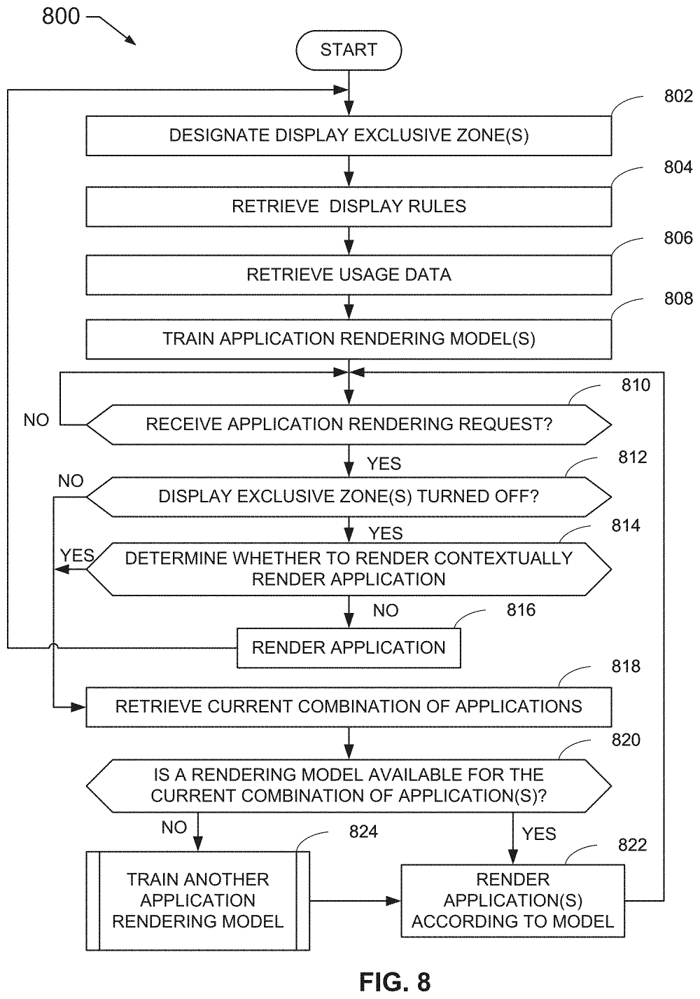

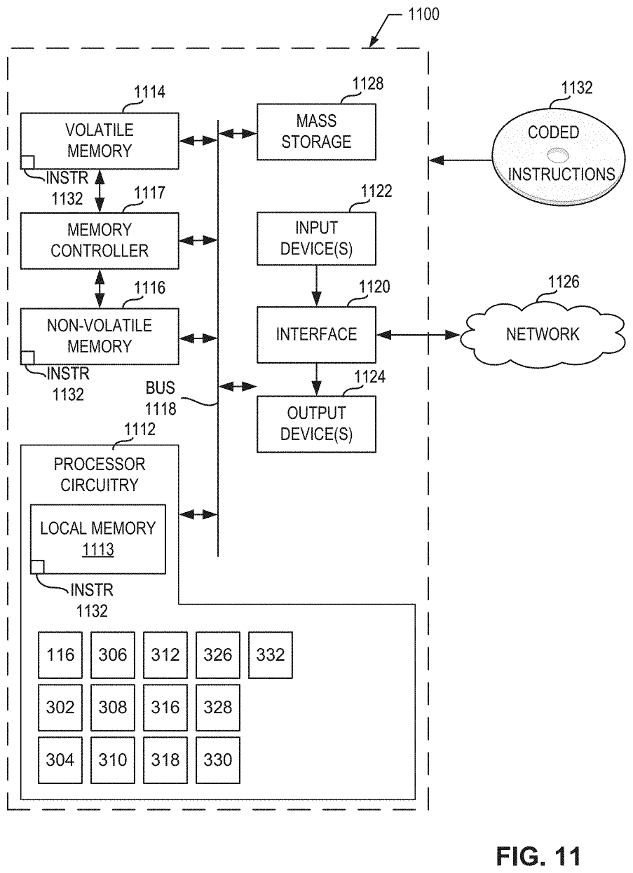

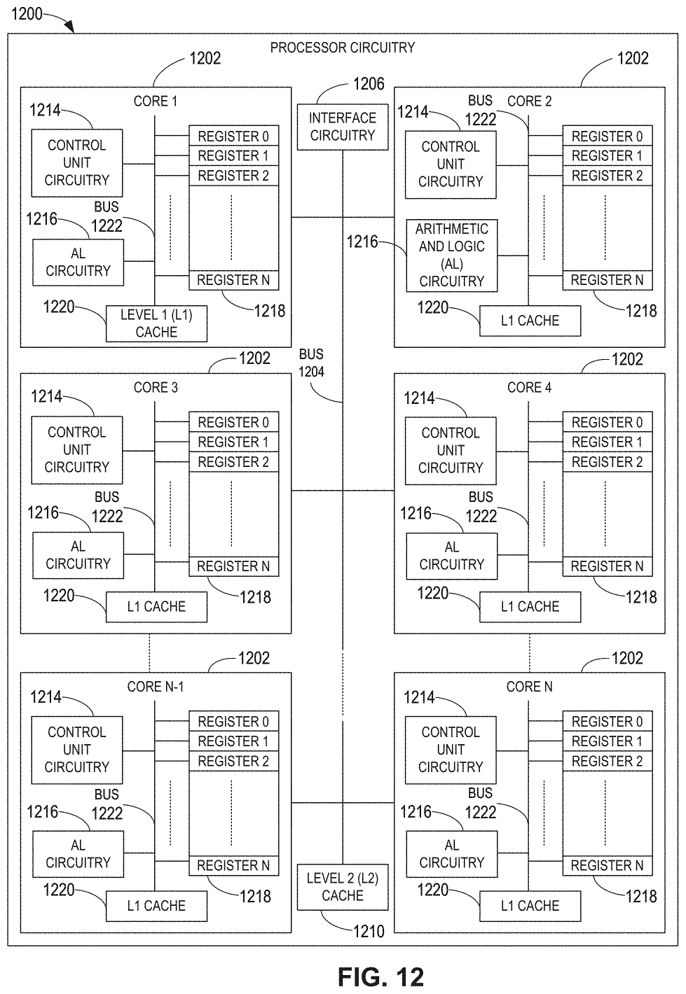

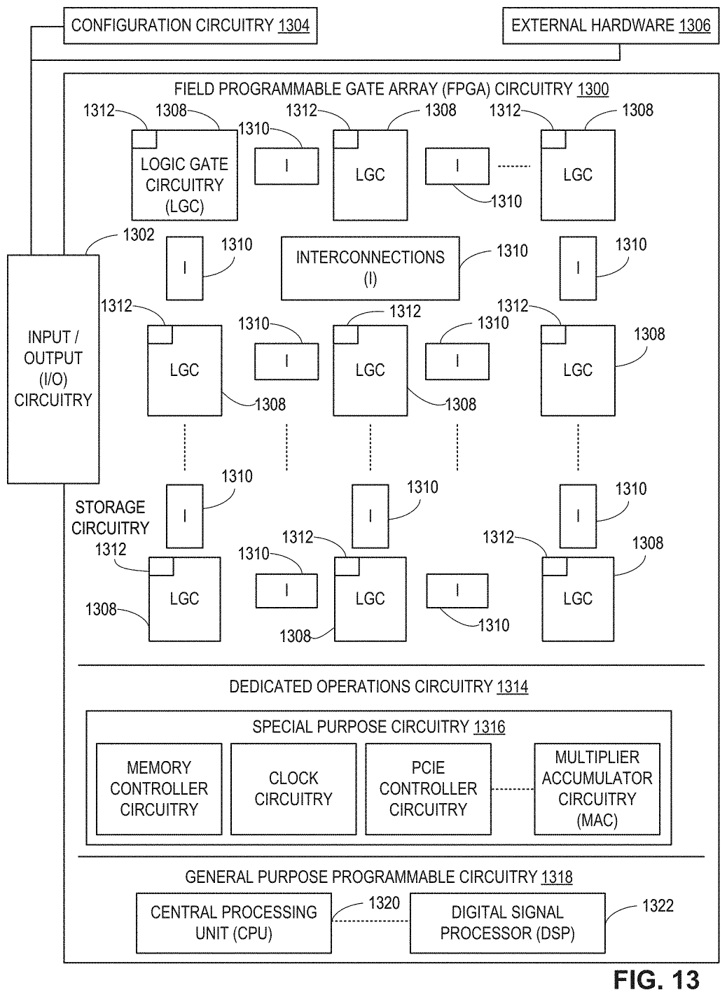

In some examples, the application rendering managing circuitry 116 includes means designating a display exclusive zone for a display screen. For example, the means for designating a display exclusive zone may be implemented by display exclusive zone configuring circuitry 302. In some examples, the display exclusive zone configuring circuitry 302 may be implemented by machine executable instructions such as that implemented by at least block 802 FIG. 8 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the display exclusive zone configuring circuitry 302 is implemented by other hardware logic circuitry, hardware implemented state machines, and/or any other combination of hardware, software, and/or firmware. For example, the display exclusive zone configuring circuitry 302 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

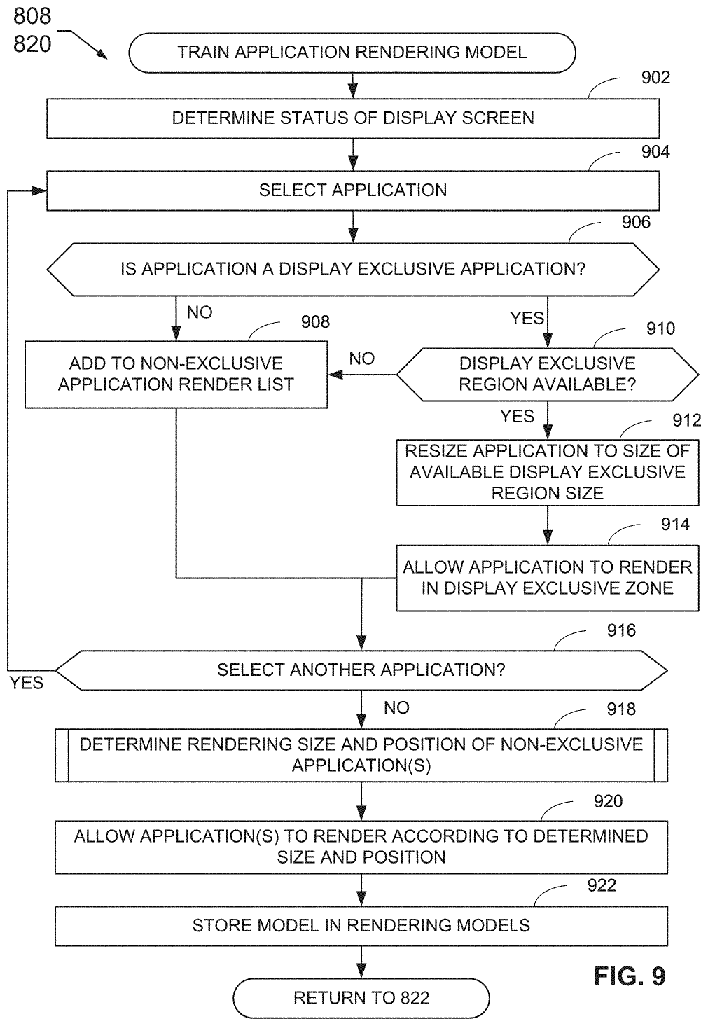

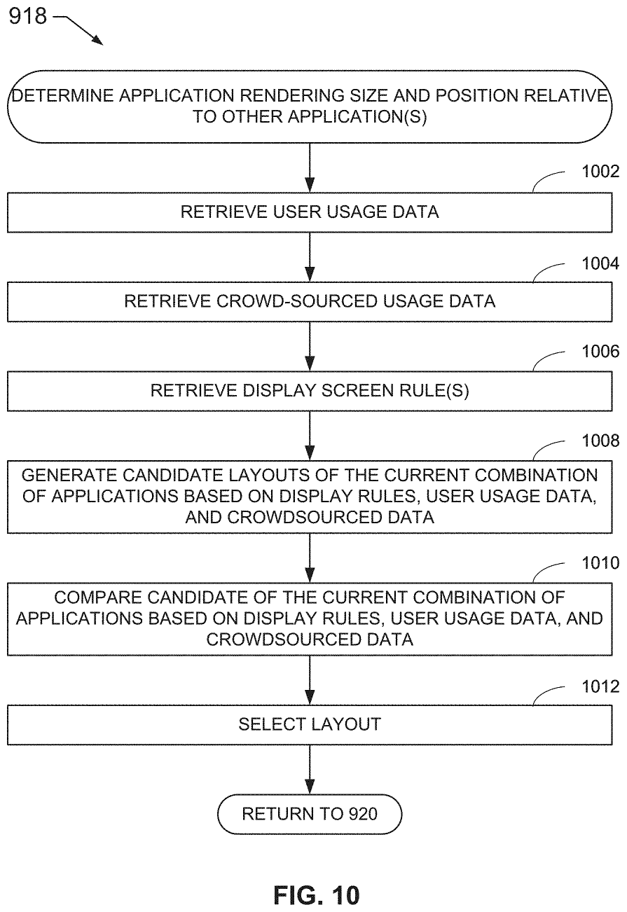

In some examples, the application rendering managing circuitry 116 includes means generating a rendering model. For example, the means for generating a rendering model may be implemented by training manager circuitry 312. In some examples, the training manager circuitry 312 may be implemented by machine executable instructions such as that implemented by at least block 804-808, 818, 824 of FIG. 8, 909-920 of FIG. 9, 1002-1012 of FIG. 10 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the training manager circuitry 312 is implemented by other hardware logic circuitry, hardware implemented state machines, and/or any other combination of hardware, software, and/or firmware. For example, the training manager circuitry 312 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the application rendering managing circuitry 116 of FIG. 1 is illustrated in FIG. 3, one or more of the elements, processes, and/or devices illustrated in FIG. 3 may be combined, divided, re-arranged, omitted, eliminated, and/or implemented in any other way. Further, the example display exclusive zone configuring circuitry 302, the example application render request receiving circuitry 304, the example display determining circuitry 306, the example application combination determining circuitry 308, the example application rendering circuitry 310, the example training manager circuitry 312, the example zone spatial determining circuitry 316, the example on/off circuitry 318, the example training circuitry 326, the example machine learning circuitry 328, the example layout comparator circuitry 330, the example selector circuitry 332, and/or, more generally, the example application rendering managing circuitry 116 of FIG. 3, may be implemented by hardware alone or by hardware in combination with software and/or firmware. Thus, for example, any of the example display exclusive zone configuring circuitry 302, the example application render request receiving circuitry 304, the example display determining circuitry 306, the example application combination determining circuitry 308, the example application rendering circuitry 310, the example training manager circuitry 312, the example zone spatial determining circuitry 316, the example on/off circuitry 318, the example training circuitry 326, the example machine learning circuitry 328, the example layout comparator circuitry 330, the example selector circuitry 332, and/or, more generally, the example application rendering managing circuitry 116, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example application rendering managing circuitry 116 of FIG. 3 may include one or more elements, processes, and/or devices in addition to, or instead of, those illustrated in FIG. 3, and/or may include more than one of any or all of the illustrated elements, processes and devices.

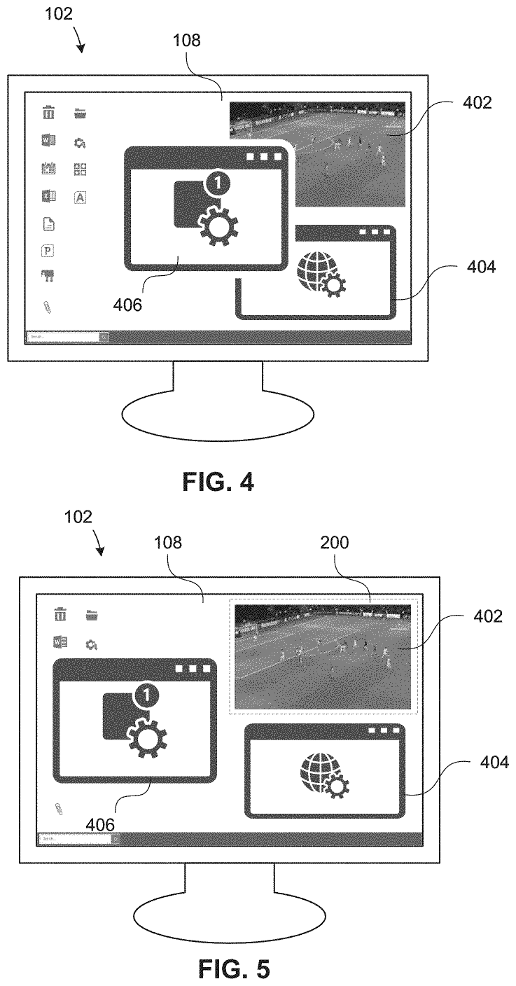

FIG. 4 is an illustration of an example computing device (e.g., computing device 102) including an example display screen (e.g., display screen 108). In this example, the display screen 108 does not include a display exclusive zone. As illustrated in FIG. 4, a first application window 402 has been launched for viewing a soccer game, and a second application window 404 has been launched featuring a webpage. A third application window 406 (also referred to herein as a “notification window”) has been launched displaying a notification (e.g., to a user). In this example, the third application window 406 is a from background application and the user did not initiate the rendering of the third application window 406. The example notification window 406 is rendered in a manner that overlaps (i.e., covers) a portion of the first application window (the soccer game) 402. While the user may close, move, and/or re-size the notification window 406, doing so requires manual user intervention and may disrupt the user's enjoyment of the soccer game.

FIG. 5 is an illustration of the example computing device 102 and the display screen 108 of FIG. 4 with a configured display exclusive zone (e.g., display exclusive zone 200) in accordance with the teachings of this disclosure. Similar to FIG. 4, a first application window 402 featuring a soccer game and a second application window 404 featuring a webpage have been launched (e.g., by a user). The first application window 402 has been designated as display exclusive content (to render the soccer game in a manner that will not be disturbed by one or more rendering interruptions). As such, the first application window 402 resides within the display exclusive zone 200 as illustrated in FIG. 5. A notification window (e.g., notification 406) has been launched by a background application running a background script. However, in this example, the notification window 406 has been rendered in accordance with the teachings of this disclosure. As such, the notification window 406 rendered in a manner that does not interfere with the user's view of the soccer game 402, which resides within the display exclusive zone 200.

In the illustrated example of FIG. 5, the notification 406 rendered in a manner that is still capable of getting the user's attention. Because many notifications that render from background scripts may still be important for a user, a notification such as notification 406 renders intelligently so as to not disrupt the display exclusive zone but to gain the user's attention. In some examples, the notification may render contextually. In some examples, application rendering management circuitry 318 may render the notification according to user usage data and/or crowdsourced usage data. For example, the application rendering management circuitry 318 may render the notification 406 in a lower left quadrant of the display screen 108 if said quadrant is a quadrant rarely used by a user.

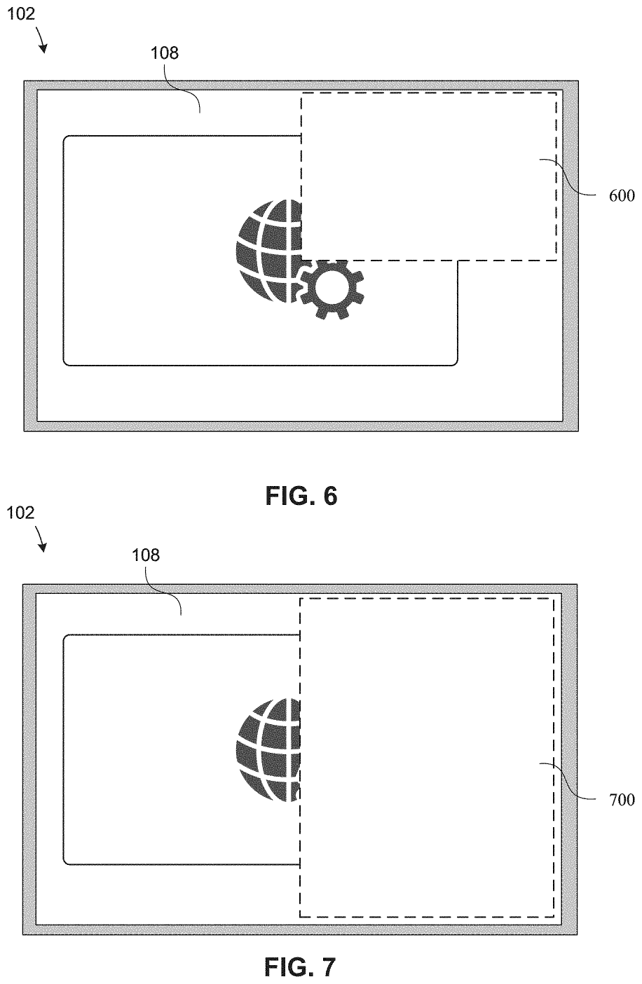

FIG. 6 is an illustration of another example display exclusive zone 600 configured under an example second mode of operation. Under the example second mode of operation, the display exclusive zone 600 is configured as an application window (e.g., widget). In some examples, the display exclusive zone 600 is configured via an operating system setting of the computing device 102. In some examples, content to be rendered in the display exclusive zone 600 is re-sized according to the size of the display exclusive zone 600. In some examples, content to be rendered within the display exclusive zone 600 maintains its original size. In such examples, a user may scroll through the content in the display exclusive zone 600.

While a display exclusive zone 200 configured under a first mode of operation as described above and illustrated in FIG. 3 and a second display exclusive zone 600 configured under a second mode of operations are configured under different modes of operation, in some examples, they operate in similar manners. A main difference between a first mode of operation and a second mode of operation is that a display exclusive zone 200 under a first mode of operation is configured in terms of screen real estate, while a display exclusive zone 600 configured under a first mode of operation is configured as an application window.

A display exclusive zone 600 operating under a second mode of operation as disclosed herein remains in view of a user as new applications render. In some examples, an application may render partially behind the display exclusive zone 600 so long as the application remains in interactive focus. In some examples, an application that will render in a manner that takes the application out of interactive focus may be resized and/or relocated. For example, an application that will render in a manner that takes the application out of interactive focus may be moved a measured distance away wherein the measured distance is a distance that puts the application back into interactive focus.

FIG. 7 is an illustration of the display exclusive zone 600 of FIG. 6 wherein a user re-configured a size to generate display exclusive 700. The display exclusive zone 700 of FIG. 7 occupies approximately one half of the display screen 108, as opposed to the display exclusive zone 600 occupying approximately one quadrant of the display screen 108 of FIG. 6. FIG. 7 also illustrates that the content within the display exclusive 700 is not re-sized according to a size of the display exclusive zone 600 of FIG. 6. Rather, a user is able to scroll through an application window that resides within the display exclusive zone 700.

Flowcharts representative of example hardware logic circuitry, machine readable instructions, hardware implemented state machines, and/or any combination thereof for implementing the application rendering managing circuitry 116 of FIG. 1 and/or FIG. 3 are illustrated in FIGS. 8-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The programs may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire programs and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 8-10, many other methods of implementing the example application rendering managing circuitry 116 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A. B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine-readable instructions and/or example operations 800 that may be executed and/or instantiated by processor circuitry to implement the application rendering managing circuitry 116. The machine readable instructions and/or operations 800 of FIG. 8 begin at block 802, where an example display exclusive zone (e.g., display exclusive zones 200, 600 and/or 700) is designated via the example display exclusive zone configuration circuitry 302. At block 804, the example training circuitry 326 retrieves the display rules 314 from the display management storage 118. At block 806, the training circuitry 326 retrieves usage context data. For example, the training circuitry may retrieve user usage data 322 and/or information from the crowdsourced datastore 104 for use in training a rendering model. At block 808, the training circuitry 326 generates one or more rendering model(s) 324 via the machine learning engine circuitry 328 and based on the user usage data 322 and/or crowdsourced datastore 104 in view of the display rules 314. For example, the training circuitry 326 uses the user usage data 322 and crowdsourced datastore 104 to generate rendering models 324 based on a common and/or different combinations of application windows and common sizes and positions of those application window combinations.

At block 810, the example application render request receiving circuitry 304 determines whether a request to render an application has been made. If the answer to block 810 is NO, the application render request receiving circuitry 304 continues to monitor and wait. When the application render request receiving circuitry 304 retrieves, receives, and/or otherwise detects a render request (e.g., from a user) (block 810), the example ON/OFF circuitry 318 inquires whether the display exclusive zone is switched to off (block 812). If the answer to block 812 is YES and the display exclusive zone is switched off, the display determining circuitry 306 determines whether to contextually render the application by requesting such information from the display rules 314 (block 814). If the answer to block 814 is NO and the example display determining circuitry 306 determines not to performed contextual rendering, then normal rendering in instantiated (block 822). However, if the display determining circuitry 306 determines that contextual rendering is to occur (block 814), then control advances to block 818. Returning to block 812, if the answer is NO (i.e. the display exclusive zone is not switched off) the control advances to block 818.

At block 818, the application combination determining circuitry 308 determines a current combination of applications running on the computing device 102. The display determining circuitry 306 then determines whether a rendering model 324 is available for the current combination of applications (block 820). If the answer to block 820 is YES, the application rendering circuitry 310 renders the current combination of applications according to the rendering model 324 (block 822). Control then advances back to block 810 where the application render request receiving circuitry 310 waits to receive another render request. If the answer to block 820 is NO, the application determining circuitry 306 generates instructions to cause the training manager circuitry 312 to train another application rendering model 324. Upon the training manager circuitry 312 generating a rendering model 324 for the current combination of applications, the application rendering circuitry 310 renders the applications according to the newly created rendering model 324 (block 822). Control then advances back to block 810 where the application render request receiving circuitry 310 waits to receive another render request.

FIG. 9 is a flowchart representative of example machine-readable instructions and/or example operations 808, 824 that may be executed and/or instantiated by processor circuitry to train an application rendering model 324. The machine readable instructions and/or operations 808, 824 of FIG. 9 begin at block 902, at which the display determining circuitry 306 determines a current status of the display screen 108, including size and position of the display exclusive zone and size of a remaining portion(s) of the display screen 108. At block 904, the training circuitry 326 selects a first one of the current combination of applications. At block 906, the training circuitry 306 determines whether the first one of the current combination of applications is designated as a display exclusive application by requesting the information from the display exclusive zone application data 320. If the answer to block 906 is NO, the training circuitry 326 adds the application to a list of applications to contextually render via the machine learning engine circuitry 328 at block 918. Control advances back to block 916, where the training circuitry 326 determines whether to select another application.

If the answer to block 906 is YES and the application is a display exclusive application, the training circuitry 326 determines whether a display exclusive zone is available (block 910). If the answer to block 910 is YES, the training circuitry 326 resizes the application to a size of an available display exclusive zone (block 912). At block 914, the training circuitry 326 generates instructions that allow the application to render in the available display exclusive region. Control advances back to block 916, where the training circuitry 326 determines whether to select another application. If the answer to block 910 is NO (i.e., the training circuitry 326 determines that no display exclusive zone is available), the training circuitry 326 decides to render the application as a non-display exclusive application and adds the application to list of applications to contextually render via the machine learning engine circuitry 328 (block 908).

The training circuitry 326 determines whether to select another application at block 916. Once the training circuitry 326 determines there are no more applications to select, control advances to block 918. At block 918, the training circuitry 326 determines a rendering size and position of the applications of the list of applications to render to contextually render via the machine learning engine circuitry 328, thereby creating another rendering model 324. After the training circuitry 326 trains another application rendering model 324 via the machine learning engine circuitry and a size and position of the non-exclusive applications is determined, the display training circuitry 326 generates instructions to allow the application(s) to render according to the determined size and position (block 920). At block 922, the training circuitry 326 stores the determined size and positions of the current combination of applications as a rendering model.

FIG. 10 is a flowchart representative of example machine-readable instructions and/or example operations 918 that may be executed and/or instantiated by processor circuitry to implement the training circuitry 326. The machine readable instructions and/or operations 918 of FIG. 10 begin at block 1002, at which the training circuitry 326 retrieves user usage data 322, crowdsource data (block 1004), and display rules (block 1006). At block 1008, the training circuitry 326 generates possible layouts of the current combination of applications based on display rules, user usage data, an/or crowdsourced data. At block 1010, the layout comparator 330 compares the possible layouts of the current combination of applications based on display rules, user usage data, and/or crowdsourced data. At block 1012, the layout selector 332 selects one of the possible layouts.

FIG. 11 is a block diagram of an example processor platform 1100 structured to execute and/or instantiate the machine readable instructions and/or operations of FIGS. 8-10 to implement the application rendering managing circuitry 116 of FIG. 3. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example display exclusive zone configuring circuitry 302, the example application render request receiving circuitry 304, the example display determining circuitry 306, the example application combination determining circuitry 308, the example application rendering circuitry 310, the example training manager circuitry 312, the example zone spatial determining circuitry 316, the example on/off circuitry 318, the example training circuitry 326, the example machine learning circuitry 328, the example layout comparator circuitry 330, and the example selector circuitry 332.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM). Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example display settings 110, database 112, example display management storage 118, example crowdsourced datastore 104, example display rules 314, example display exclusive zone application data 320, user usage data 322, and example rendering models 324 is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output devices 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1132, which may be implemented by the machine readable instructions of FIGS. 8-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 1. In this example, the processor circuitry 1112 of FIG. 11 is implemented by a microprocessor 1200. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIGS. 8-10.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L 1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The bus 1222 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowchart of FIGS. 8-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIGS. 8-10. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowchart of FIGS. 8-10. As such, the FPGA circuitry 1300 may be structured to effectively instantiate some or all of the machine readable instructions of the flowchart of FIGS. 8-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 8-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 8-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates. Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modem FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowchart of FIGS. 8-10 may be executed by one or more of the cores 1202 of FIG. 12 and a second portion of the machine readable instructions represented by the flowcharts of FIGS. 8-10 may be executed by the FPGA circuitry 1300 of FIG. 13.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

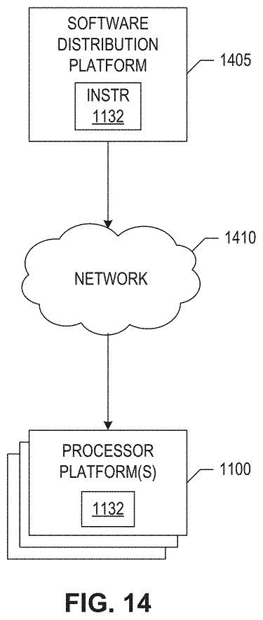

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 800-1000 of FIGS. 8-10, as described above. The one or more servers of the example software distribution platform 1405 are in communication with a network 1410, which may correspond to any one or more of the Internet and/or any of the example networks 106 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 800-1000 of FIGS. 8-10, may be downloaded to the example processor platform 1100, which is to execute the machine readable instructions 1132 to implement the application rendering managing circuitry 116. In some example, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that designate a display exclusive zone. Examples disclosed herein configure a display exclusive zone that remains in a user's view regardless of other applications rendering. In examples disclosed herein, an application that will render in a manner to obscure a view of the display exclusive zone will be moved and/or re-sized so as to not block the display exclusive zone. Systems, methods, apparatus, and articles of manufacture have also been disclosed that contextually render applications according to user usage data and/or crowdsourced data. Example disclosed systems, methods, apparatus, and articles of manufacture improve the efficiency of using a computing device by allowing a user of the compute device to work effectively and simultaneously with multiple application windows, with less manual intervention and/or visual distraction. Examples disclosed herein also improve safety of computing devices and/or other systems that may be controlled and/or monitored by the computing device. For instance, in the event the computing device controls and/or monitors factory machine, then warning messages, status screens, and/or other safety critical information will not be obscured from view on the display thereby allowing prompt management of such factor equipment. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to designate a display exclusive zone of a display screen are disclosed herein. Further examples and combinations thereof include the following:

Example 1 includes a computing device to designate a display exclusive zone, the computing device comprising at least one memory, instructions in the computing device, and processor circuitry to execute the instructions to: designate a portion of a display screen as a display exclusive zone, the display exclusive zone having a first spatial location, the display exclusive zone including first content, in response to receiving a request to render second content, determine a second spatial location of the second content, in response to determining the second spatial location encroaches the first spatial location, adjust the second spatial location to a third spatial location, and render the second content in the third spatial location.

Example 2 includes the computing device of example 1, wherein first content and second content is sourced by at least one of an application or an operating system.

Example 3 includes the computing device of any of examples 1-2, wherein first content is display exclusive content and the processor circuitry is to execute the instructions to designate an application source as the first content, and in response to receiving a request to render the first content, render the first content in the display exclusive zone.

Example 4 includes the computing device of example 3, wherein rendering the first content in the display exclusive zone causes the processor circuitry to execute the instructions to access a mode of the display exclusive zone and render the first content according to the mode of the display exclusive zone.

Example 5 includes the computing device of any of examples 1-4, wherein the second content includes content that renders on the display screen outside the display exclusive zone.

Example 6 includes the computing device of any of examples 1-5, wherein adjusting the second spatial location of the second content causes the processor circuitry to execute the instructions to determine whether a rendering model exists for the second content, and in response to determining the rendering model exists, adjust the second spatial location to the third spatial location according to the rendering model.

Example 7 includes the computing device of any of examples 1-6, wherein the processor circuitry is to execute the instructions to generate a rendering model for the second content when the rendering model does not exist for the second content.

Example 8 includes the computing device of example 7, wherein generating the rendering model for the second content causes to the processor circuitry to execute the instructions to select the second content, retrieve at least one of user usage data, crowdsourced usage data, or display screen rules, generate a candidate layout of the second content based on the at least one of user usage data, crowdsourced data, or display rules, compare a first candidate layout and a second candidate layout based on the at least one of user usage data, crowdsourced usage data, or display rules, and select a layout of the second content based on the at least one of user usage data, crowdsourced usage data, or display rules.

Example 9 includes a method for designating a display exclusive zone, including designating a portion of a display screen as a display exclusive zone, the display exclusive zone having a first spatial location, the display exclusive zone including first content, in response to receiving a request to render second content, determining a second spatial location of the second content, in response to determining the second spatial location encroaches the first spatial location, adjusting the second spatial location to a third spatial location, and rendering the second content in the third spatial location.

Example 10 includes the method of example 9, wherein first content and second content is sourced by at least one of an application or an operating system.

Example 11 includes the method of any of examples 9-10, where first content is display exclusive content, the method further including designating an application source as the first content, and in response to receiving a request to render the first content, rendering the first content in the display exclusive zone.

Example 12 includes the method of example 11, wherein rendering the first content includes accessing a mode of the display exclusive zone, and rendering the first content according to the mode of the display exclusive zone.

Example 13 includes the method of any of examples 9-12, wherein the second content includes content that renders on the display screen outside the display exclusive zone.

Example 14 includes the method of any of examples 9-13, wherein adjusting the second spatial location of the second content includes determining whether a rendering model exists for the second content, and in response to determining the rendering model exists, adjusting the second spatial location to the third spatial location according to the rendering model.

Example 15 includes the method of any of examples 9-14, further including generating a rending model for the second content in response to determining a rendering model does not exist for the second content.

Example 16 includes the method of example 15, wherein generating the rendering model for the second content includes selecting the second content, retrieving at least one of user usage data, crowdsourced usage data, or display screen rules, generating a candidate layout of the second content based on the at least one of user usage data, crowdsourced data, or display rules, comparing a first candidate layout and a second candidate layout based on the at least one of user usage data, crowdsourced usage data, or display rules, and selecting a layout of the second content based on the at least one of user usage data, crowdsourced usage data, or display rules.

Example 17 includes at least one non-transitory computer readable medium comprising computer readable instructions that, when executed, cause at least one processor to at least designate a portion of a display screen as a display exclusive zone, the display exclusive zone having a first spatial location, the display exclusive zone including first content; in response to receiving a request to render second content, determine a second spatial location of the second content; in response to determining the second spatial location encroaches the first spatial location, adjust the second spatial location to a third spatial location; and render the second content in the third spatial location.

Example 18 includes the at least one non-transitory computer readable medium of example 17, wherein the computer readable instructions cause the at least one processor to source the first content and the second content by at least one of an application or an operating system.

Example 19 includes the at least one non-transitory computer readable medium of any of examples 17-18, wherein first content is display exclusive content, and the computer readable instructions further cause the at least one processor to designate an application source as the first content, and in response to receiving a request to render the first content, render the first content in the display exclusive zone.

Example 20 includes the at least one non-transitory computer readable medium of example 19, wherein to render first content in the display exclusive zone, the computer readable instructions further cause the at least one processor to designate an application source as the first content, and in response to receiving a request to render the first content, render the first content in the display exclusive zone.

Example 21 includes the at least one non-transitory computer readable medium of any of examples 17-20, wherein the computer readable instructions cause the at least one processor to render the second content on the display screen outside the display exclusive zone.

Example 22 includes the at least one non-transitory computer readable medium of any of examples 17-21, wherein to adjust the second spatial location of the second content, the computer readable instructions further cause the at least one processor to determine whether a rendering model exists for the second content, and in response to determining the rendering model exists, adjust the second spatial location to the third spatial location according to the rendering model.

Example 23 includes the at least one non-transitory computer readable medium of any of examples 17-22, wherein the computer readable instructions further cause the at least one processor to generate a rendering model for the second content in response to determining the rendering model does not exist for the second content.

Example 24 includes the at least one non-transitory computer readable medium of example 23, wherein to generate the rendering model for the second content, the computer readable instructions further cause the at least one processor to select the second content; retrieve at least one of user usage data, crowdsourced usage data, or display screen rules; generate a candidate layout of the second content based on the at least one of user usage data, crowdsourced data, or display rules; compare a first candidate layout and a second candidate layout based on the at least one of user usage data, crowdsourced usage data, or display rules; and select a layout of the second content based on the at least one of user usage data, crowdsourced usage data, or display rules.

The following claims are hereby incorporated into this Detailed Description by this reference, with each claim standing on its own as a separate embodiment of the present disclosure.

What is claimed is:

1. A computing device to designate a display exclusive zone, the computing device comprising:
at least one memory;
instructions in the computing device; and
processor circuitry to execute the instructions to:
designate a portion of a display screen as a display exclusive zone, the display exclusive zone having a first spatial location, the display exclusive zone including first content;
in response to receiving a request to render second content, determine a second spatial location of the second content;
in response to determining the second spatial location encroaches the first spatial location, adjust the second spatial location to a third spatial location; and
render the second content in the third spatial location.

2. The computing device of claim 1, wherein first content and second content is sourced by at least one of an application or an operating system.

3. The computing device of claim 1, wherein first content is display exclusive content and the processor circuitry is to execute the instructions to:
designate an application source as the first content; and
in response to receiving a request to render the first content, render the first content in the display exclusive zone.

4. The computing device of claim 3, wherein rendering the first content in the display exclusive zone causes the processor circuitry to execute the instructions to:
access a mode of the display exclusive zone; and
render the first content according to the mode of the display exclusive zone.

5. The computing device of claim 1, wherein the second content includes content that renders on the display screen outside the display exclusive zone.

6. The computing device of claim 1, wherein adjusting the second spatial location of the second content causes the processor circuitry to execute the instructions to:
determine whether a rendering model exists for the second content; and
in response to determining the rendering model exists, adjust the second spatial location to the third spatial location according to the rendering model.

7. The computing device of claim 1, wherein the processor circuitry is to execute the instructions to generate a rendering model for the second content in response to determining the rendering model does not exist for the second content.

8. The computing device of claim 7, wherein generating the rendering model for the second content causes to the processor circuitry to execute the instructions to:
select the second content;
retrieve at least one of user usage data, crowdsourced usage data, or display screen rules;
generate a candidate layout of the second content based on the at least one of user usage data, crowdsourced data, or display rules;
compare a first candidate layout and a second candidate layout based on the at least one of user usage data, crowdsourced usage data, or display rules; and
select a layout of the second content based on the at least one of user usage data, crowdsourced usage data, or display rules.

9. A method to designate a display exclusive zone, the method comprising:
designating, by executing an instruction with at least one processor, a portion of a display screen as a display exclusive zone, the display exclusive zone having a first spatial location, the display exclusive zone including first content;
in response to receiving a request to render second content, determining, by executing an instruction with the at least one processor, a second spatial location of the second content;
in response to determining the second spatial location encroaches the first spatial location, adjusting, by executing an instruction with the at least one processor, the second spatial location to a third spatial location; and
rendering, by executing an instruction with the at least one processor, the second content in the third spatial location.

10. The method of claim 9, wherein first content and second content is sourced by at least one of an application or an operating system.

11. The method of claim 9, where first content is display exclusive content, the method further including:
designating an application source as the first content; and
in response to receiving a request to render the first content, rendering the first content in the display exclusive zone.

12. The method of claim 11, wherein rendering the first content includes:
accessing a mode of the display exclusive zone; and
rendering the first content according to the mode of the display exclusive zone.

13. The method of claim 9, wherein the second content includes content that renders on the display screen outside the display exclusive zone.

14. The method of claim 9, wherein adjusting the second spatial location of the second content includes;
determining whether a rendering model exists for the second content; and
in response to determining the rendering model exists, adjusting the second spatial location to the third spatial location according to the rendering model.

15. The method of claim 9, further including generating a rending model for the second content in response to determining a rendering model does not exist for the second content.

16. The method of claim 15, wherein generating the rendering model for the second content includes:
selecting the second content;
retrieving at least one of user usage data, crowdsourced usage data, or display screen rules;
generating a candidate layout of the second content based on the at least one of user usage data, crowdsourced data, or display rules;
comparing a first candidate layout and a second candidate layout based on the at least one of user usage data, crowdsourced usage data, or display rules, and
selecting a layout of the second content based on the at least one of user usage data, crowdsourced usage data, or display rules.

17. At least one non-transitory computer readable medium comprising computer readable instructions that, when executed, cause at least one processor to at least:
designate a portion of a display screen as a display exclusive zone, the display exclusive zone having a first spatial location, the display exclusive zone including first content;
in response to receiving a request to render second content, determine a second spatial location of the second content;
in response to determining the second spatial location encroaches the first spatial location, adjust the second spatial location to a third spatial location; and
render the second content in the third spatial location.

18. The at least one non-transitory computer readable medium of claim 17, wherein the computer readable instructions cause the at least one processor to source the first content and the second content by at least one of an application or an operating system.

19. The at least one non-transitory computer readable medium of claim 17, wherein first content is display exclusive content, and the computer readable instructions further cause the at least one processor to:
designate an application source as the first content; and
in response to receiving a request to render the first content, render the first content in the display exclusive zone.

20. The at least one non-transitory computer readable medium of claim 19, wherein to render first content in the display exclusive zone, the computer readable instructions further cause the at least one processor to:
designate an application source as the first content; and
in response to receiving a request to render the first content, render the first content in the display exclusive zone.

21. The at least one non-transitory computer readable medium of claim 17, wherein the computer readable instructions cause the at least one processor to render the second content on the display screen outside the display exclusive zone.

22. The at least one non-transitory computer readable medium of claim 17, wherein to adjust the second spatial location of the second content, the computer readable instructions further cause the at least one processor to:
determine whether a rendering model exists for the second content; and
in response to determining the rendering model exists, adjust the second spatial location to the third spatial location according to the rendering model.

23. The at least one non-transitory computer readable medium of claim 17, wherein the computer readable instructions further cause the at least one processor to generate a rendering model for the second content in response to determining the rendering model does not exist for the second content.

24. The at least one non-transitory computer readable medium of claim 23, wherein to generate the rendering model for the second content, the computer readable instructions further cause the at least one processor to:
select the second content;
retrieve at least one of user usage data, crowdsourced usage data, or display screen rules;
generate a candidate layout of the second content based on the at least one of user usage data, crowdsourced data, or display rules;
compare a first candidate layout and a second candidate layout based on the at least one of user usage data, crowdsourced usage data, or display rules; and
select a layout of the second content based on the at least one of user usage data, crowdsourced usage data, or display rules.
